(19) United States
(12) Patent Application Publication
(10) Pub. No.: US 2018/0270300 A1
(43) Pub. Date: Sep. 20, 2018

(54) SUPPORTING INTERNET PROTOCOL (IP) CLIENTS IN AN INFORMATION CENTRIC NETWORK (ICN)

(71) Applicant: InterDigital Patent Holdings, Inc., Wilmington, DE (US)

(72) Inventors: Alexander Reznik, Pennington, NJ (US); Xavier De Foy, Kirkland (CA); Scott C. Hergenhan, Collegeville, PA (US); John Cartmell, North Massapequa, NY (US); Michelle Perras, Montréal (CA)

(73) Assignee: InterDigital Patent Holdings, Inc., Wilmington, DE (US)

(21) Appl. No.: 15/517,849

(22) PCT Filed: Oct. 7, 2015
(86) PCT No.: PCT/US2015/054541

§ 371 Date: Apr. 7, 2017

(51) Int. Cl. H04L 29/08; H04L 29/12

(52) U.S. Cl. CPC H04L 67/1002; H04L 69/16; H04L 61/1511

(57) ABSTRACT

Systems, methods, and instrumentalities are disclosed for providing Information Centric Networking (ICN) within a network, comprising detecting a request for content from a wireless transmit/receive unit (WTRU) that is in the network, selecting a network element for the WTRU to attach to, wherein the network element is selected without regard to properties of the content requested, and providing the content to the WTRU. A request to publish content from a WTRU in the network may include determining, based on content name, whether to publish the content in the network or outside the network, and if the content is to be published in the network, selecting a network element for the WTRU to attach to, wherein the network element is selected without regard to properties of the content requested, and causing the network element to accept the content from the WTRU.

### CROSS REFERENCE TO RELATED APPLICATIONS

This application claims the benefit of U.S. Provisional Patent Application Ser. No. 62/061,075, filed Oct. 7, 2014, the entire contents of which are hereby incorporated by reference herein.

### BACKGROUND

IP-based network architecture is designed around allowing a pair of machines (hosts) to communicate. Hosts may be assigned addresses. Intermediate network nodes (e.g., routers) may be configured to route packets to a destination by determining a suitable “next hop” based on a destination IP address and router configuration. IP-based data network architecture is based on i) host-to-host communication and/or ii) routing as the single fundamental in-network operation. This IP-based approach to networking has evolved into the fundamental component of the majority of data networks.

The host-to-host communication paradigm was a good match for user communication needs, which typically involved two-way communication sessions (e.g., calls) or access to information from a well-known location (e.g., file server on a LAN or FTP site). However, since the World Wide Web (WWW) has become the primary application for IP based networking, host-to-host communication has become less efficient.

### SUMMARY

Systems, methods, and instrumentalities are disclosed for providing Information Centric Networking (ICN) within a network (e.g., a single network), comprising detecting a request for content from a wireless transmit/receive unit (WTRU) that is in the network, selecting a network element for the WTRU to attach to, wherein the network element is selected without regard to properties of the content requested, and providing the content to the WTRU through the selected network element.

Systems, methods, and instrumentalities are disclosed for providing Information Centric Networking (ICN) within a network (e.g., a single network), comprising detecting a request to publish content from a wireless transmit/receive unit (WTRU) that is in the network, determining, based on content name, whether to publish the content in the network or outside the network, and, if the content is to be published in the network: selecting a network element for the WTRU to attach to, wherein the network element is selected without regard to properties of the content requested, and causing the network element to accept the content from the WTRU.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 is a diagram illustrating an example system architecture where Information Centric Networking (ICN) services exist within a network.

FIG. 3 is a diagram illustrating an example architecture and interaction for local content services.

FIG. 4 is a diagram illustrating an example of a user interface view of a local publication and exemplary interaction with a local content network.

FIG. 5 is a diagram illustrating an example of architecture of local Content Services and interaction between components.

FIG. 6 is a diagram illustrating an example of internal architecture for Local Content Services and interaction between components.

FIG. 7 is a diagram illustrating an example of interaction between WTRUs and a Local Content Network to establish connections.

FIG. 8 is a diagram illustrating an example of a WTRU publishing a content object that is pushed into the network for “immediate” publication.

FIG. 9 is a diagram illustrating an example of a WTRU publishing a content object that is pulled into the network for “deferred” publication.

FIG. 10 is a diagram illustrating an example of a WTRU getting a content object cached in ICN network Front End 1.

FIG. 11 is a diagram illustrating an example of a WTRU getting a content object cached in ICN network Front End 2. Front End 1 may decide to cache the object, for example, during the process of retrieving the content from Front End 2.

FIG. 12 is a diagram illustrating an example of a WTRU getting a content object that is not cached in the ICN network.

FIG. 13 is a diagram illustrating an example of a Client-Front End Association Algorithm in the Context of an Application.

FIG. 14 is a block diagram illustrating an example of an architecture for a Small Cell Network Gateway (SCN GW).

FIG. 15 is a block diagram illustrating an example of SCN and core network architecture.

FIG. 16 is a block diagram illustrating an example of anchoring based on cache location topology within the SCN and core network architecture shown in FIG. 15.

FIG. 17 is a diagram illustrating an example of message sequencing for Cache Location Anchoring.

FIG. 18 is a diagram illustrating an example of message sequencing for Cache Location Anchoring.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

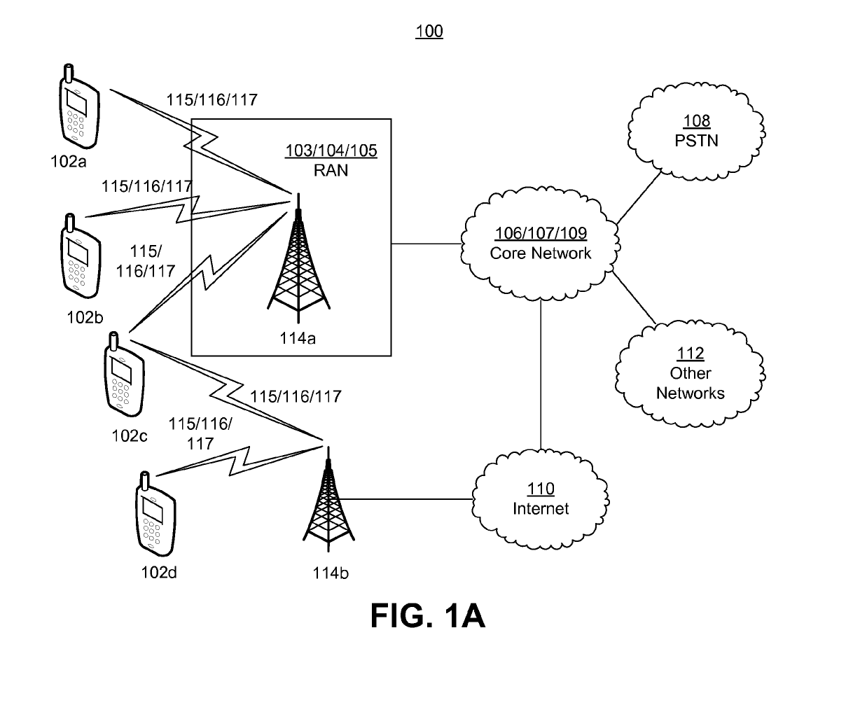

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs), e.g., WTRUs, 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include wireless transmit/receive unit (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in some embodiments, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In some embodiments, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some embodiments, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in some embodiments, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In some embodiments, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In some embodiments, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

It is understood that the client device (such as, for example, a WTRU) may connect to an ICN network, such as will be described, wirelessly (for example, LTE, 802.11, etc.) or via wired (for example, Ethernet) approaches.

IP-based network architecture is designed around allowing a pair of machines (e.g., hosts) to communicate. Hosts may be assigned an address (or addresses). Intermediate network nodes (e.g., routers) may be configured to route packets to a destination by determining a suitable next hop based on a destination IP address and router configuration. IP-based data network architecture may be based on host-to-host communication and/or routing in-network operation.

Using the WWW, a user may request a specific piece of information (e.g., by specifying its URI). The user's expectation is that the network delivers this information from any appropriate location. Given that the information may be content, the two notions (e.g., of information and content) may be intermixed. Content may be fairly static and immutable. Information may be dynamic, mutable, and/or evolve in time.

An information-retrieval model may be distinct from a pairwise host-to-host communication model. Content/information may be collected in chunks. A user may not know or care if the chunks originate in the same location. The delivery process for information may be made much more efficient when information is collected from multiple sources. For example, in-network caching may be utilized to take advantage of nearby stores that may not be known to the user, etc. Communication in an information-retrieval model may be multi-point-to-point, whereas communication in a host-based model may be point-to-point. Information retrieval communication may be built around a name of information a user is interested in, as opposed to an address of a particular network node. While a name may uniquely identify a specific piece of information, it may not refer to any copies of the information.

Information Centric Networking (ICN) may introduce name-based networking, so that information may be requested by name to allow network entities (e.g., ICN routers) to make decisions based on routers.

Information-retrieval may be addressed with overlay solutions, such as HTTP-based approaches. The underlying IP-based network may be retained and a URI-based infrastructure may be built on top of it, acting as if it were a name-based network. An example process of retrieving particular content may operate as follows. A user may request www.example.com/my_example_pic.jpg by clicking on it in a browser. The user's browser may resolve www.example.com using a DNS by sending www.example.com to a centralized database that returns an IP address, for example 128.127.126.125, known to be the location of the machine known as www.example.com. The user's browser may request (e.g., sends an HTTP GET) for my_example_pic.jpg to 128.127.126.125. The example.com Web server at 128.127.126.125 may realize that it is not the best location to service this user with this content (e.g., and/or it may not even have the content). The Web server may re-direct the user to another URL where it knows the content to be. The process may repeat itself, potentially several times. For example, if the owner redirects to a CDN, the first request may be to a centralized CDN management system, which then re-directs to actual location. In the meantime, the content may be located right along the path of these requests. While a complex technique involving packet inspection, proxies, etc. could discover the content, there may not be a natural and reasonable way for the network to realize this and/or act on such a realization given that the network is essentially composed of routers.

In an ICN network, an example procedure to request www.example.com/my_example_pic.jpg may operate as follows. The user may request www.example.com/my_example_pic.jpg by clicking on it in a browser. The browser may issue an ICN INTEREST for www.example.com/my_example_pic.jpg. An ICN ROUTER receiving the ICN interest may forward it and/or service it locally (e.g., if it has the content cached). If an ICN ROUTER forwards the interest, it may route the response (e.g., with the content) once it comes back. Content may be delivered in chunks. In an ICN approach, it may be up to a user's device (e.g., browser) to integrate the chunks and/or an intermediate router may integrate the chunks.

An ICN network procedure may include fewer exchanges. An ICN procedure may allow a network to optimize how content is provided to a client, and to do so dynamically. Instead of being locked in to particular service points based on an initial DNS resolution, an ICN procedure may respond to changes in network and traffic conditions, take advantage of in-network content distribution, etc.

Hardware support for Software Defined Networking may allow introduction of ICN-based networking technologies (e.g., whether IP overlay and/or non-IP ICN-based implementations) within a single network. A network may be internally upgraded towards support of ICN using a gradual, low-cost, low-risk software upgrade that permits ICN and legacy software to coexist for a very long time. This may result in a gradual upgrade and deployment approach where HTTP-overlay of host-to-host communication and ICN based network protocols and management are deployed side-by-side in the same network.

An ICN network may interact with a variety of client devices operating with an IP-stack under a host-to-host communication paradigm. While devices may increasingly contain ICN protocol stacks, a wide-spread shift towards such technologies may take years. Billions of web-enabled client devices may not be upgraded in the near future with a completely different protocol stack, which may involve a major change in device operating system. A change in the protocol stack away from an IP-based stack may affect the socket interface, which is used by most non-web-based applications. Thus, an IP-based stack in client devices may persist for a very long time.

Client devices may continue to access content using a content-retrieval protocol, such as HTTP over an IP protocol stack. A network may continue to support this client access method while allowing it to operate ICN-based network protocols internally. While a client's IP socket may be connected to a specific IP address for the benefit of a client application, a network may serve requested content from any appropriate location, several simultaneous locations and/or may change the service location dynamically in response to network dynamics. While reference is made to HTTP as an example application protocol for content delivery to a client over IP networks, the disclosed technology is applicable to other protocols, e.g., RTP (e.g., for real-time services) or CoAP (e.g., for Machine-to-Machine applications).

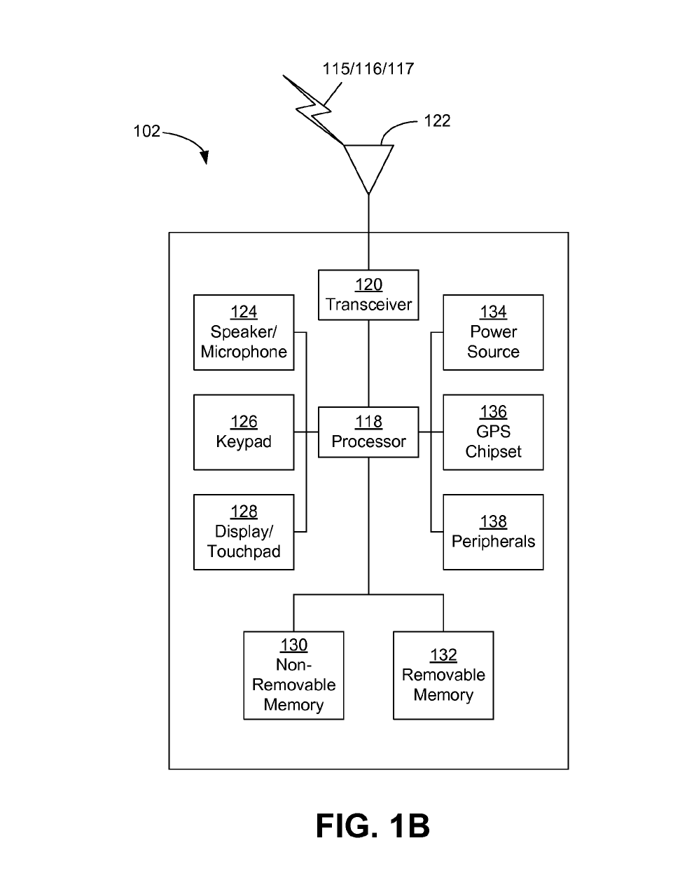

IP Clients may be supported in an ICN Content Network. A network may select a network element for a client to attach to, for example, when a network detects an attempt by a client device to obtain content. A client may establish an IP session with a network element (e.g., using TCP socket or UDP socket). An IP connection may remain terminated (e.g., anchored) at a network element for the duration of the application's IP session. A client may run an appropriate application-level protocol for content management (e.g., HTTP) over this IP socket. The anchor element may act as a proxy server toward the client. Proxy technology may be used. While a proxy proxies a specific network server, an anchor may act as a proxy for functionality that may be dynamically distributed across an ICN network. FIG. 2 is a diagram illustrating an example system architecture where ICN services exist within a network.

Selection of an anchor node for a client may not depend on properties of content a client is trying to access. For example, content properties may not be fully known when a socket is set up or configured. An anchor may be selected at the time a socket is being setup, for example, to maintain full transparency to the client. An anchor may be selected before a socket is set up, for example, during a DNS resolution portion of the process.

A network may retrieve client application communications from a selected network element, for example, after a socket is set up.

A network may process the communications in a manner appropriate for ICN architecture within the network. Specific network processing may depend on the network.

DNS-based redirection for local content services may be used to support IP clients in an ICN content network. Content may be distributed by a local network. A client may be directly connected to a local network. The local network may provide content distribution services for an application. The application may benefit from having content distribution managed in a local network close to the user. An example might be an application, e.g., augmented reality, where most content is locally generated and locally consumed. A DNS-redirection based approach may be used to support IP clients in an ICN content network.

Edge caching in a 3GPP network with direct interconnects may be used to support IP clients in an ICN content network. A network of interconnected 3GPP cells may offer in situ content storage capabilities to an application. Content may be cached in an interconnected cell. This local storage point (e.g., instead of a remote cloud server) may be used to service a local user. 3GPP bearers may be managed (e.g., set up and terminated).

A content network anchoring method based on DNS-based redirection for local content services may be used to support IP clients in an ICN content network.

A Fully Qualified Domain Name (FQDN) may be an absolute, unambiguous domain name, such as host.mydomain.com. An FQDN may be used to specify any level of the DNS, e.g., mydomain.com or sub1.sub2.mydomain.com. A GET http://fqdn/path and a POST http://fqdn/path may be used as simplified notations for an HTTP GET or POST for host “fqdn” that target a resource /path on this host.

Local Content Services may enable client applications to perform local publication and retrieval, e.g., while at a venue (e.g., a stadium, a mall, etc.). Content may be stored locally in the venue and may not transit over the backhaul.

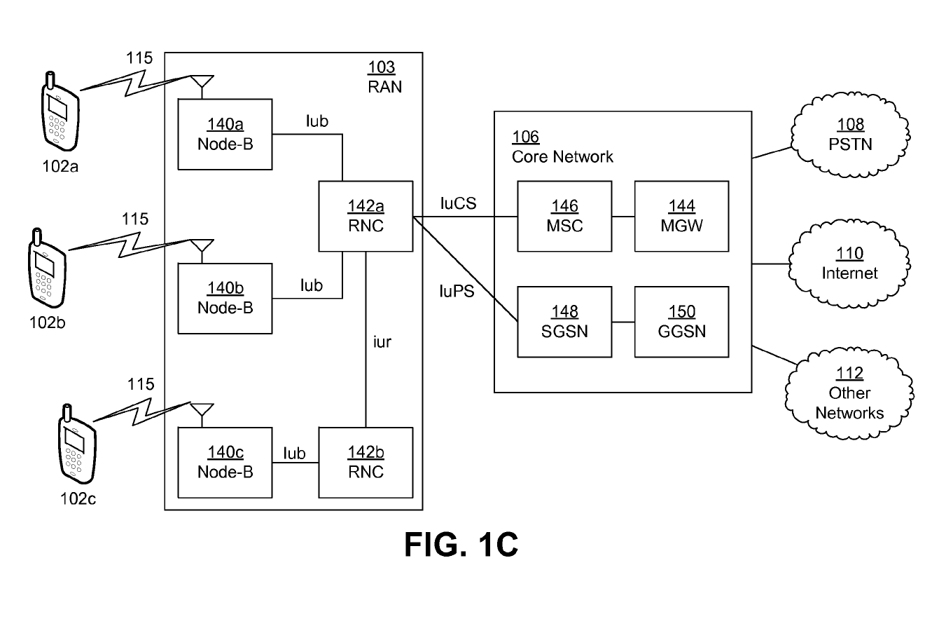

FIG. 3 is a diagram illustrating examples of architecture and interaction for local content services. Local Content Network may provide local content services. The Local Content Network may implement Local Content Services. Local Content Network may provide, for example, a control interface to Application Service Provider and a data plane interface to WTRUs.

Local Content Network may enable client applications running on end user devices to publish content locally and to obtain a name (e.g., URI) from the publication process. The URI may be available, e.g., distributed, to other local clients. Other local clients may retrieve the local content from the Local Content Network using the URI.

In an “Event” use case for local content services, the location may be a stadium, a concert hall, a hotel holding a conference, or any other venue where a crowded event takes place. During the event, attendees and event organizers may generate a large amount of content of interest to other attendees, and perhaps to some outside the venue. An information-sharing model may be related, for example, to the models of Twitter® and Instagram®, where people access content generated by others, with whom they may have a prior relationship, based on similarity of interest, or for other reasons, e.g., content of interest. A content network may track what content is accessed the most, and, for example, push such content to an over-the-top content service beyond a venue.

In a mall use case for local content services, a location may be a mall or other dense commercial area, where content may be pushed locally by business operators and/or local shoppers. Local content may be information on products, promotions, or other commercial content.

In an example of local content services, such as, for example, an “Event” use case, a mall use case, or a variety of other use cases, augmented reality may be used. For example, photos, videos and other information may be positioned in a virtual space super-imposed over the environment by a tool, such as Google® Glass. Some information may be used locally. Some information may be stored in a local content network, which may avoid unnecessary backhaul link traffic. In an example, augmented reality information related to a city may be spread over a content network across the city, where the content network may be formed of interconnected local content networks, each covering certain areas of the city.

Application Service Provider may be a customer of Local Content Service provider. Application Service Provider may be, for example, an Application Provider such as Twitter®, Instagram®, Facebook®, and/or a local application focusing on a specific venue, e.g., an application enabling local sharing in a given stadium. An application may permit an exchange of content, such as photos and videos, between end users, among other features, such as likes, comments, and so on.

Wireless transmit/receive unit (WTRU) may be a personal computing device (for example, such as a smart phone, a tablet, or laptop computer). WTRUs may be located in the venue.

Application Service Provider may have a client component running on a WTRU. As an example, a single-page web application may have JavaScript code running in the browser. A client component may be a Local Content Services-Enabled Client (LCS Enabled Client) in the sense that it may be aware of and may be able to invoke an interface, e.g., a REST interface, offered by the Local Content Network. For example, the client component may issue an “HTTP POST/publish” to publish a content object and “HTTP GET/object/<content name>” to retrieve an object.

Referring to FIG. 3, at 0, an agreement may be put in place between the Application Service Provider and the Local Content Network Operator. Part of this (e.g., a business aspect) may be set up out of band. Application Service Provider, e.g., upon gaining access to a control interface exposed by the Local Content Network, may set up domains, policies, etc.

At 1, a WTRU may start the application (e.g., navigate to the application main page in a browser) and open a session (e.g., log in).

At 2, the application client (e.g., browser application) may be aware of the domain name to use for local content services. For example, a single-page application's JavaScript has a variable lcs_domain=“lcs.appname.com”, where appname.com is a domain the Application Service Provider may use to serve the application.

Referring to FIG. 3, at 3, the application client may detect the presence of Local Content Services, for example, using an HTTP GET http://lcs.appname.com/. The client application may display user interface elements enabling publication, for example, upon becoming aware that Local Content Network is present.

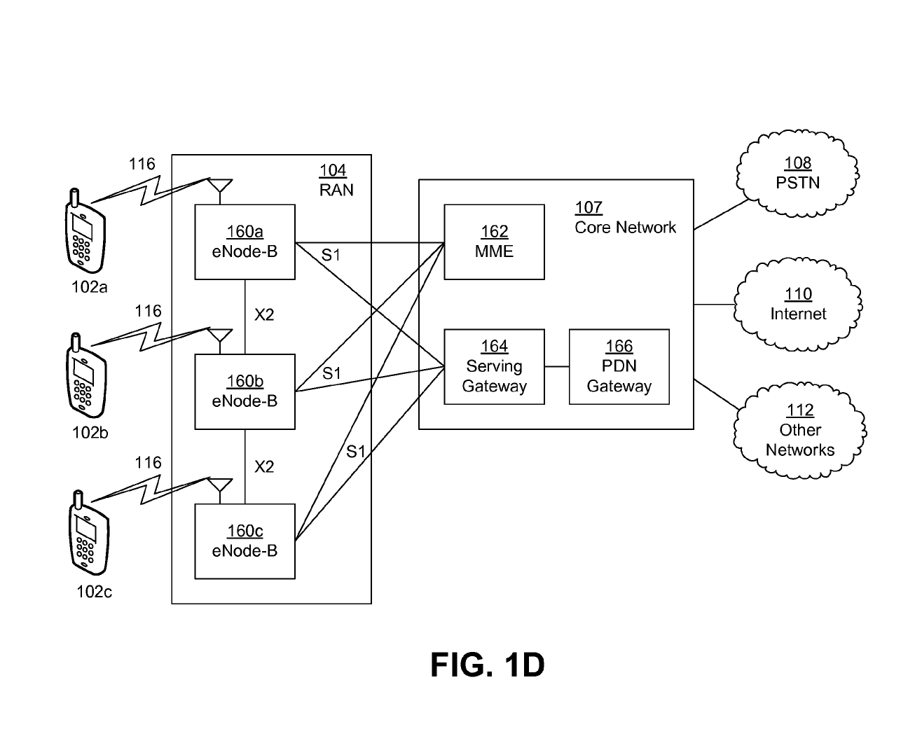

FIG. 4 focuses on the user interface displayed by the application client. FIG. 4 is a diagram illustrating an example of a user interface view of a local publication and exemplary interaction with a local content network. FIG. 4 presents the point of view of WTRU1.

At a of FIG. 4, the end user may decide to publish a photo, for example, by interacting with the user interface on the page by clicking a button to select the photo file. The client application may publish the content object to the Local Content Network, for example, using HTTP POST http://lcs.appname.com/publish. The Local Content Network may return a URI to retrieve the object (e.g., http://lcs.appname.com/object/1234).

At b, the client application may distribute a message post, for example, through the application session.

At c, the application server may redistribute the post to some or all of users' feed, which may be displayed by the clients.

Returning to FIG. 3, at 4, a second WTRU starts an application session. The client application may fetch the latest content from the feed and display this on a screen for the second WTRU.

At 5, the end user may, for example, read the feed, decide to watch the content published by the first end user, and click on the appropriate field in the displayed feed.

At 6, the client application may fetch the content object, e.g., using HTTP GET http://lcs.appname.com/object/1234.

Content network anchoring may be enabled through a DNS request from the client to a subdomain that may be known a priori by the client application, e.g., lcs.appname.com. The Application Provider, which may be the owner of the domain appname.com, may configure the DNS server authoritative for appname.com to make the Local Content Service Provider's DNS server authoritative for lcs.appname.com. The Local Content Service Provider may implement an algorithm deciding which Front End may be allocated to a specific query by a client. The decision may be based on, for example, one or more of Front End load information, client location, expected traffic requirements, application name, etc.

Content networking technology used within Local Content Network may be several possible technologies, for example, including but not limited to, Information Centric Networks (ICNs) based on CCN, PURSUIT, NetInf or other ICN technology, other content networks, such as Content Delivery Networks (e.g., Akamai®'s CDN, Level 3®) or peer-to-peer networks.

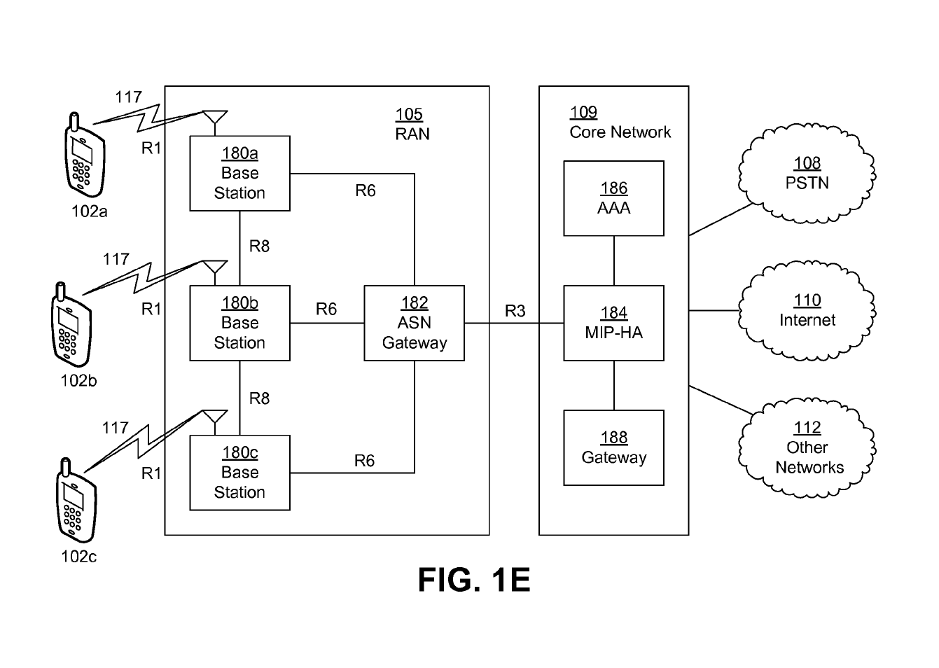

FIG. 5 is a diagram illustrating examples of architecture of local Content Services and interaction between components. FIG. 5 focuses on the relation between the actors, system components, and their location.

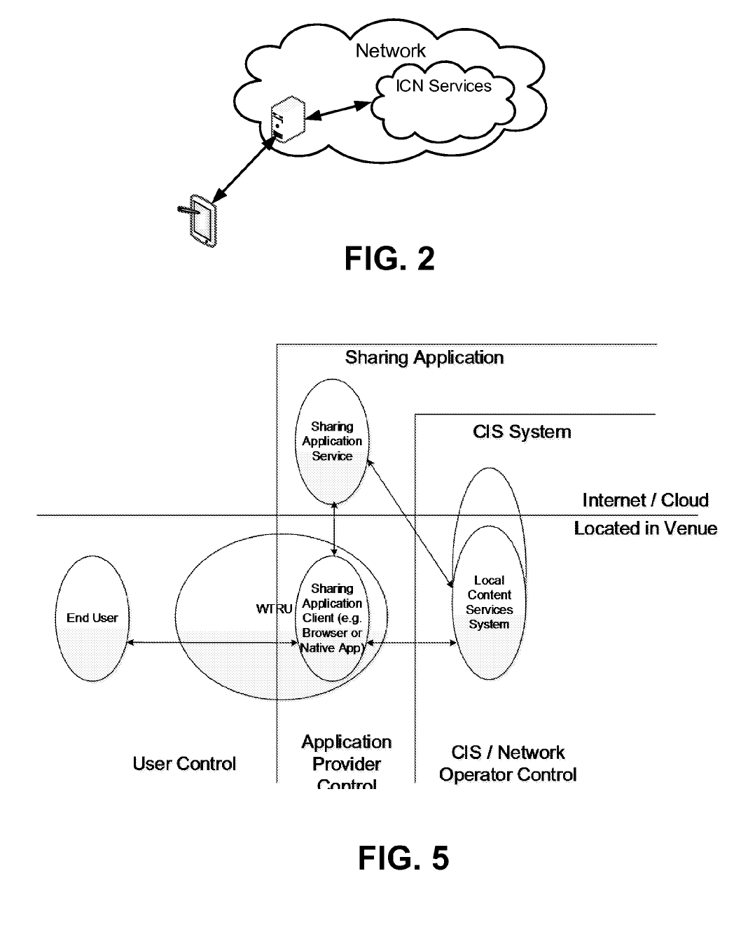

FIG. 6 is a diagram illustrating examples of internal architecture for Local Content Services and interaction between components. In FIG. 6, Local Content Network may comprise Content Router Node, Control Node and Front-End Nodes. Interfaces are indicated as C1-C5. The client on the WTRUs may be aware of and may use the local content network's API. A client may have an application layer awareness. A WTRU may not need to be provisioned with specific code to interface with the local content network. For example, a browser running on the WTRU may download a one-page application from the application server, which may contain JavaScript code that makes use of the REST interface exposed by Front End nodes.

Control Node may function as a DNS request router. Control Node may determine which front end may handle a particular WTRU connection for a given FQDN. In an example, the DNS Server may perform load balancing between several front end nodes for clients within the IP block of the venue, but may provide a negative response to other requests. A component, e.g., Client-Front End Association Component, may be in charge of configuring the DNS Server to achieve certain goals under certain constraints. Control Node may obtain information from the Front End nodes, e.g., over NetConf, and implements logic, for example, to optimize WTRU/FQDN/Front End association. This may enable more accurate load balancing and other advanced behavior. Control Node may configure the Front End nodes, for example, to perform certain actions such as access control or specific retention policy.

Front End (FE) Node may interact with a WTRU for a given FQDN. A WTRU may get content objects from the FE and may publish content objects to the FE. FE node may be an ICN router that may be interconnected with other FE and CR nodes, which may form an ICN network. The FE may publish the content object in the ICN network, for example, once a WTRU publishes a content object. The FE may allocate a content name to published content. A content object may be named in ICN and may be named as a regular URL. Names may be related, for example, to enable automatic translation from one to the other. Front End nodes may have a storage capacity to cache content objects.

Content Router Node may node be similar to the Front End. Content Router Node may not have an interface with a WTRU.

C1 may be a DNS interface from WTRU to network. C1 may be an interface through the DNS system between the WTRU and the Local Content Network Provider's DNS server. C1 may be used, for example, to serve the IP addresses of Front Ends that may be appropriate for a certain WTRU.

C2 may be a WTRU to Front End Node interface. C2 may be a REST API implemented by the Front End node. C2 may be used by the client application on the WTRU. A C2 API may enable local publication and retrieval of content. A C2, API may have a long term connection component, such as a WebSocket connection. The connection may be used to enable deferred publication, for example, when the client publishes content without uploading it to the Local Content Network. Content may be retrieved over the WebSocket connection, for example, when the content is desired.

C3 may be a Front End to Front End interface. C3 may be an ICN interface. C3 may include an ICN user plane (e.g., using CCNx protocol) and a control plane (e.g., using OSPFN protocol). C3 may enable content publication and dissemination. Part or all of a control plane component of C3 may be replaced by or completed with a centralized control scheme over interface C4.

C4 may be a Control Node to Front End interface. The control node may use a monitoring and control protocol, e.g., NetConf, to obtain information from and configure the FE node. A function over C4 may include configuration of FQDNs (e.g., access/publish control, retention policy, other services configuration, etc.). A function over C4 may include ICN routing control, which may be in addition to or replacement of C3's control plane component.

C5 may be a Console interface. C5 may be used to configure scope access policy (e.g., list of public scopes, public key for signature verification, retention policy). C5 may be used to provide access to certain services, such as a search service. Users of C5 may be internal, such as the Local Content Network operator, through command line or web interface. Users of C5 may also be external, such as the Application Provider.

A method for DNS-based content anchoring may consist of having a group of content related to an application (e.g., appname.com) attached to an FQDN (e.g., icn.appname.com). An application may have several groups of content. Publication and retrieval operations from the WTRU may be enabled through an API using certain URIs for the FQDN. For example, the API may enable publishing with POST https://icn.appname.com/publish (e.g., a POST/publish over an HTTPS session to host icn.appname.com). The API may enable retrieval with GET https://icn.appname.com/object/1234. A GET https://icn.appname.com may be used to discover the capabilities of the Front End/Local Content Network.

A message flow may include the DNS request/response involving the WTRU and the Local Content Provider's DNS server. Message flow may include interaction of the WTRU with the Front End.

The client application on the WTRU may be aware of the FQDN, for example, to use it to interact with the Local Content Network. There may be a plurality of techniques for FQDN binding.

The Local Content Provider's DNS Server may be configured to pair clients with Front End under certain constraints.

Message flow for DNS-Based Content Anchoring may provide a connection to Local Content Network. The connection may permit WTRUs to publish and/or retrieve content.

A WTRU may initiate a DNS request to resolve a certain FQDN. The request may be resolved in the DNS system. The Local Content Provider's Authoritative DNS may process the request, for example, by selecting one or more Front End IP addresses and sending a response containing the Front End IP address(es). Pairing between the Front End node(s) and the WTRU may be complete, for example, when the WTRU receives the response. The WTRU may use the pairing, for example, to get capabilities, get content from, and/or publish content to the Local Content Network through the Front End node(s). The WTRU and Front End node(s) may engage in a capability exchange comprising, for example, an HTTP GET on URI https://X provided by the WTRU, to which the Front End may answer with a XML/JSON document indicating the capabilities of the Local Content Network. A GET request may also be used to verify that the Local Content Network is reachable through the Front End(s). In case of failure of the first GET, the client may select another Front End and retry, for example, when the DNS response holds more than one Front End.

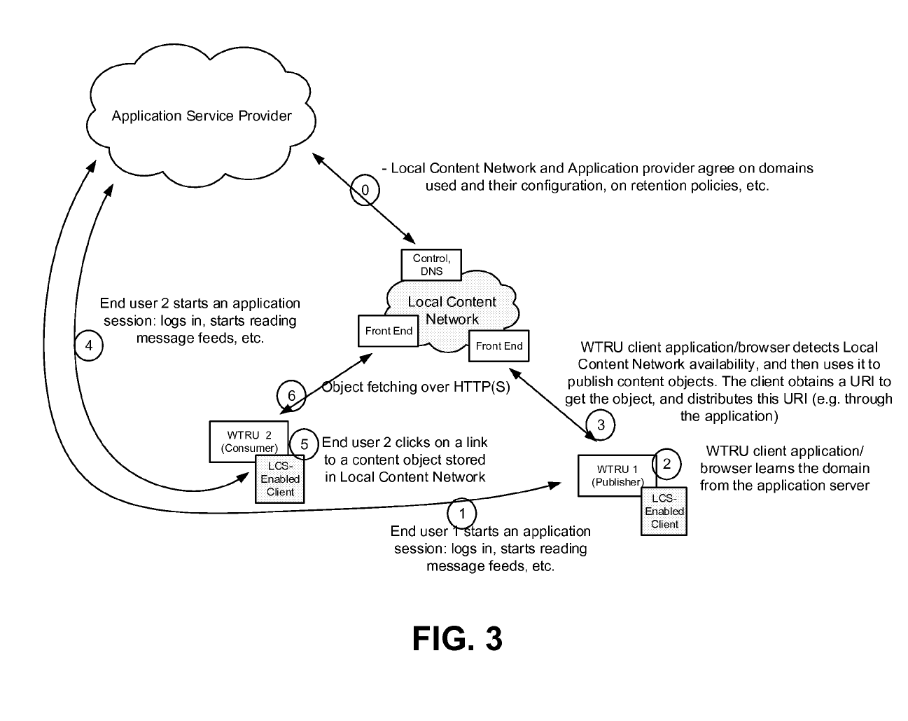

FIGS. 7-12 are diagrams illustrating examples of interaction that may be variously combined or excluded to achieve an overall procedure to establish a connection, publish and retrieve content from the Local Content Network.

There may be variations of content publication. For example, publication may be immediate, deferred, etc. Publication may be immediate, for example, when the publisher pushes a content object into the local content network. Publication may be “deferred”, for example, when the publisher indicates that it has the content object, but does not push the content. The publisher WTRU may maintain a long term bidirectional connection (e.g., a two-way communication session) with the local content network. The local content network may use the connection to pull the content object from the publisher WTRU device.

There may be variations of content retrieval. Content retrieval may vary based on, for example, where a content object is located at the time of the operation. Content may be in a cache in the front end directly connected to the consumer. Content may be cached by another node of the content network. Content may be located on the publisher's device, for example, when publication is deferred before the content object was pulled by the network.

FIG. 7 is a diagram illustrating an example of interaction between WTRUs and a Local Content Network to establish connections.

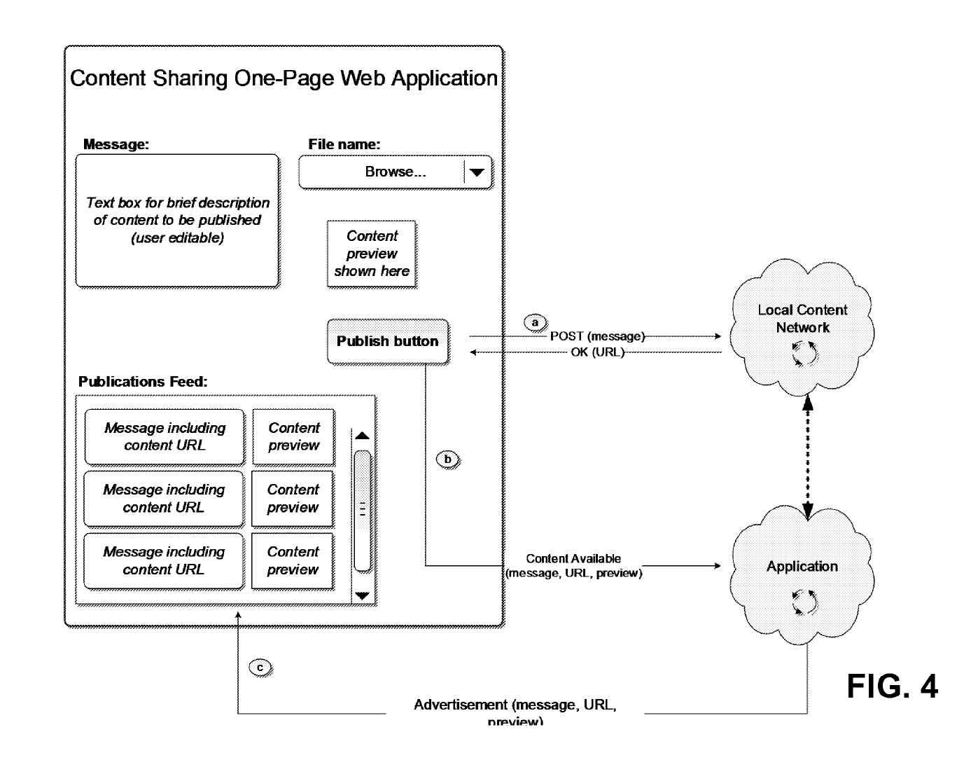

FIG. 8 is a diagram illustrating an example of a WTRU publishing a content object that is pushed into the network for “immediate” publication.

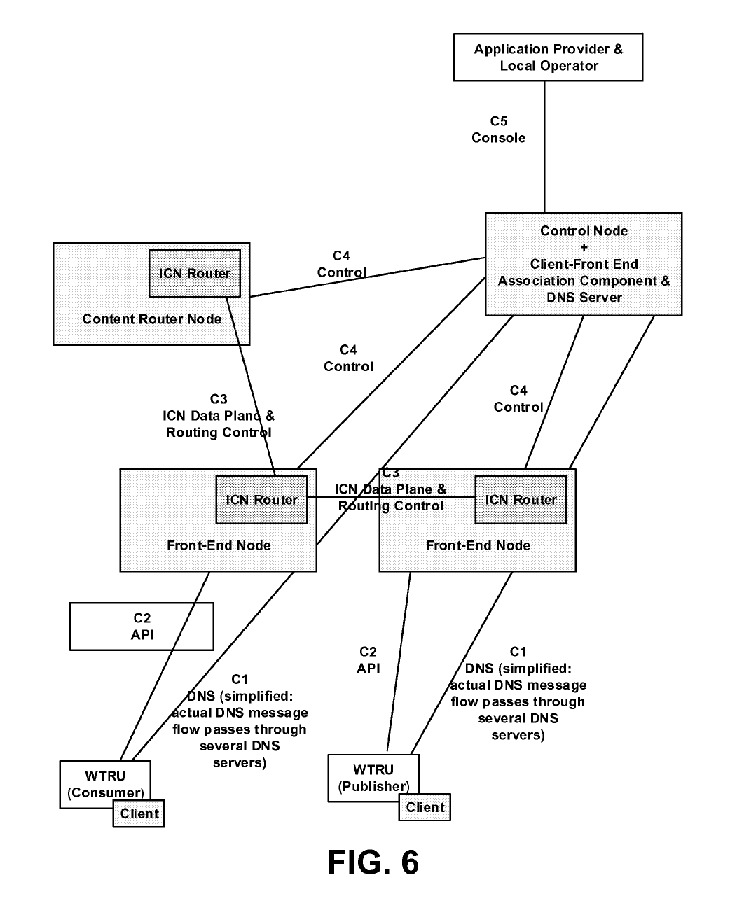

FIG. 9 is a diagram illustrating an example of a WTRU publishing a content object that is pulled into the network for “deferred” publication.

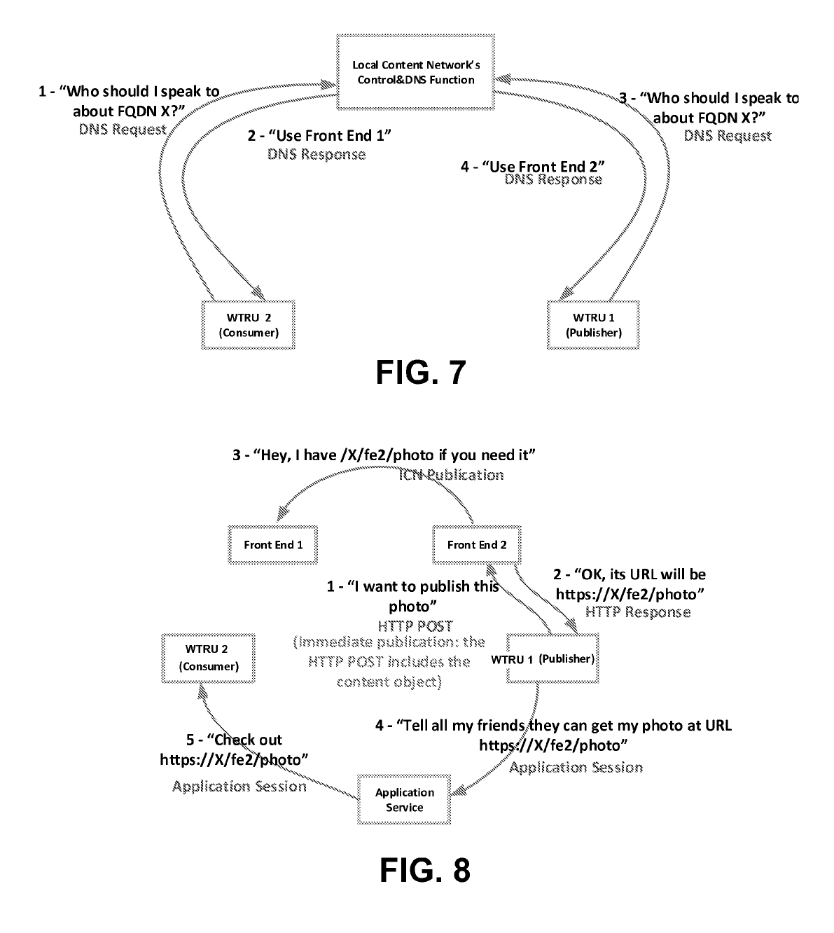

FIG. 10 is a diagram illustrating an example of a WTRU getting a content object cached in ICN network Front End 1.

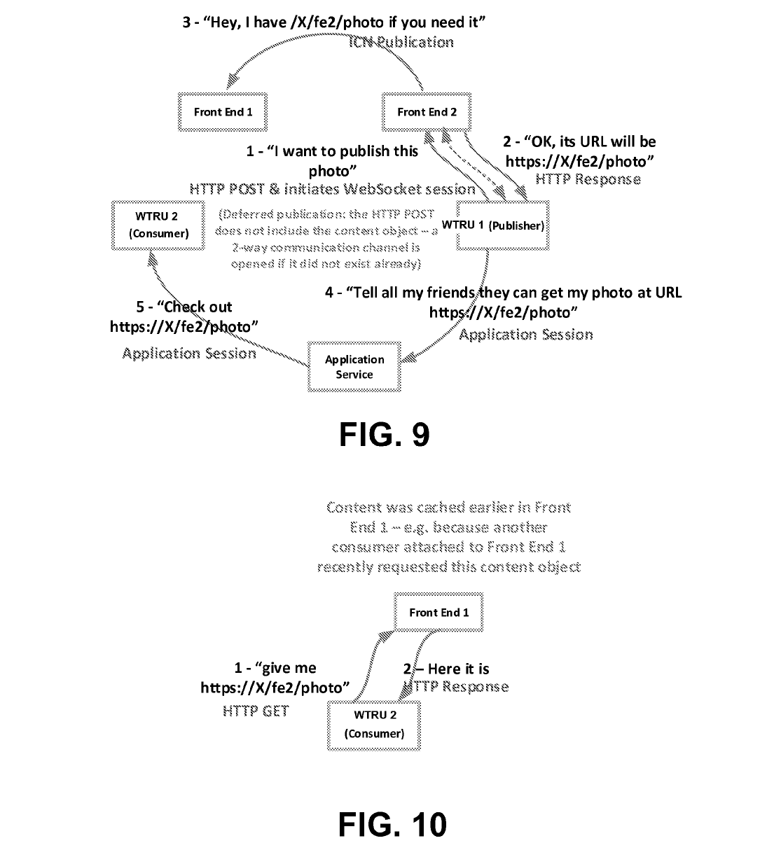

FIG. 11 is a diagram illustrating an example of a WTRU getting a content object cached in ICN network Front End 2. Front End 1 may decide to cache the object, for example, during the process of retrieving the content from Front End 2.

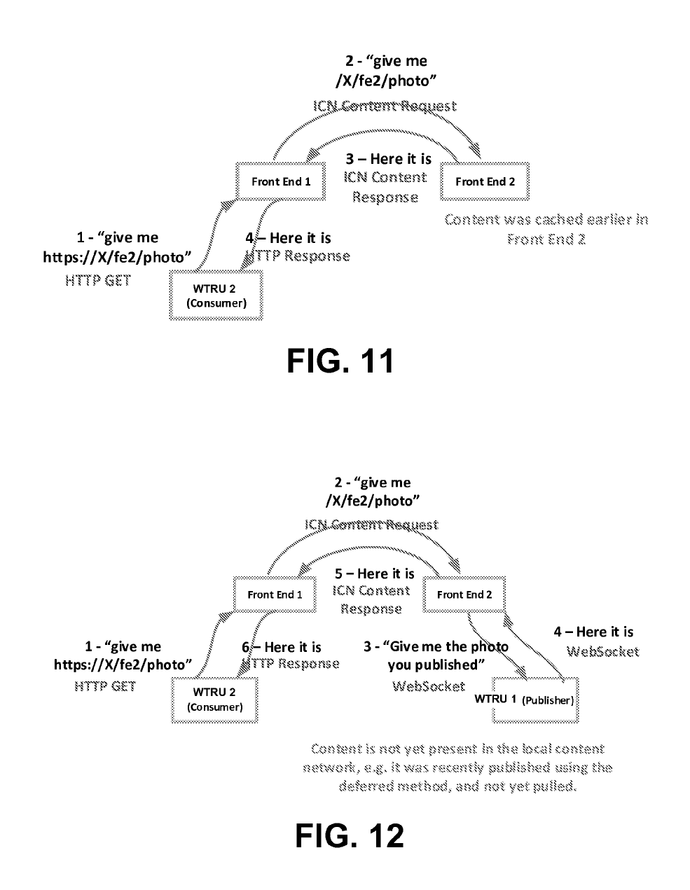

FIG. 12 is a diagram illustrating an example of a WTRU getting a content object that is not cached in the ICN network. One or more Front Ends or other ICN node may decide to cache the object, for example, during the process of pulling the content from WTRU1 (publisher).

The examples described herein may be variously assembled into a complete connection, publication and retrieval process. For example and without limitation, one or more of the following may apply. The examples in FIGS. 7, 8 and 10 may be used together as an example of a connection, publication and retrieval process. The examples of FIGS. 7, 8 and 11 may be used together as an example of a connection, publication and retrieval process. The examples in FIGS. 7, 9 and 10 may be used together as an example of a connection, publication and retrieval process. The examples in FIGS. 7, 9 and 11 may be used together as an example of a connection, publication and retrieval process. The examples in FIGS. 7, 9 and 12 may be used together as an example of a connection, publication and retrieval process.

An interface between WTRUs and Front End nodes may be implemented, for example, using a REST API. For example, POST/publish (e.g., with domain icn.appname.com) may be used to publish a file. A response may indicate the resource name that may be used in a GET to retrieve the object, e.g., /object/0fd63c85b44287fb55faf3c549b1fa91c27e7106. GET /object/0fd63c85b44287fb55faf3c549b1fa91c27e7106 may return the published object to any requester (e.g., consumer).

Front End nodes and Content Router nodes may participate in a content network (e.g., a CCN, PURSUIT, Mobility First or other type of content network). A Front End may publish content upon reception from the WTRU and may retrieve the content object when requested through a GET. A Front End may find a proper internal name for the content (e.g., the hash value of its content). A Front End may return a URI built using this name to a publisher WTRU. A publisher WTRU may transmit the URI to the other WTRUs, for example, through the application. Transmitting the URI may be achieved in many ways, for example, by micro-blogging, email, chat applications, etc. A Front End may extract a Content Name from a URI and request the appropriate content object from the Local Content Network, for example, in response to the Front End receiving a request for the URI.

An FQDN Binding may be implemented, for example, between a Local Content Provider's DNS Server and an FQDN known by an Application Provider and its client application on a WTRU. A client may need to know which FQDN to use. A DNS request may need to reach the Local Content Provider's DNS server.

FQDN binding may be implemented by a variety of techniques, some of which are presented as examples. In the examples, “IDCCapp” is used as an example of an Application Provider.

In an example, FQDN binding may be implemented by top-down delegation. An FQDN name may be, for example, video.icn.idcc.com. IDCCapp (e.g., or IDCCapp's authoritative CDN) may configure its DNS system to make the Local Content Network's DNS authoritative for icn.idcc.com, e.g., using a CNAME entry. IDCCapp client applications on WTRUs may be aware, a priori, of the FQDN to use for Local Content Services.

An FQDN binding may enable an ecosystem. For example, an over-the-top CDN (e.g., Akamai®) may have an agreement (e.g., and related interfaces) with many venue operators. Akamai's customers (e.g., Application Providers) may benefit from Local Content Services at different venues without having any direct relationship (e.g., an indirect relationship through Akamai®). IDCCapp may use icn.idcc.com to access Local Content Services. IDCCapp's client application on a WTRU may effectively connect to a Front End of the venue WTRU is located in.

An Application Provider may use a third party (e.g., Akamai®) to provide large scale use of a service while some Application Providers may not need an intermediate third party.

FQDN binding may be implemented by spoofing. An FQDN name may be, for example, video.icn.idcc.com. Local Content Provider may intercept a DNS request and pretend to be authoritative for certain FQDNs. This may be referred to as DNS spoofing. Security or usage of DNSSec may prevent FQDN binding by spoofing. A client application on a WTRU may be a priori aware of the FQDN to use for Local Content Services. A client application may know that such spoofing method will be used.

FQDN binding may be implemented by bottom-up configuration. An FQDN name may be, for example, video.icn.idcc.com.montrealstadium.com. Local Content Network operator may configure an FQDN with the Application Provider. The Application Provider may offer this capability. Application Provider, for example, a stadium operator owning the domain “montrealstadium.com,” may configure montrealstadium.com in a configuration form on its social network presence platform, e.g. a page in a social network platform, for example, IDCCsocial.

IDCCsocial, for example, may support a DNS setting for Local Content Services. A IDCCsocial webpage may, for example, have JavaScript code that attempts to discover icn.montrealstadium.com, for use such as when a user visits the IDCCsocial page of montrealstadium.com. Such a service on a IDCCsocial page may further enable Local Content Services to be accessible to the user.

A Local Content Network's DNS Server may, e.g., in response to receiving a request, extract a prefix from an FQDN (e.g., video.icn.idcc.com). This may permit the DNS Server to be aware of which application a request belongs to.

FQDN binding may be implemented by bottom-up discovery. An FQDN name may be, for example, video.icn.idcc.com.montrealstadium.com. An application client may be Local Content Services-aware. An application client may detect a Local Content Network when run. For example, Local Content Networks may advertise a service and available FQDNs using ANQP, Router advertisements, DHCP, etc.

An application client may provide a user interface to publish. An application client may use an FQDN, e.g., icn.appname.com.X, where “X” may be replaced with an FQDN learned from the detection process.

An algorithm may pair or associate Front Ends with Application Clients. A Local Content Provider's DNS Server may be configured to follow an association algorithm. A component running an algorithm and producing an output that may be used to configure the DNS Server may be referred to as Client-Front End Association Computing (CFEAC).

CFEAC inputs may include, for example, existing network state (and any existing attachment between WTRUs and Front Ends and/or Access Points), as well as new clients or range of potential new clients (e.g., IP blocks of potential local clients which should be associated with a particular Front End element).

CFEAC output may include, for example, mapping between clients and Front Ends (e.g., mapping between blocks of clients' IP addresses and Front Ends' IP addresses).

One or more applications may each have their own domain. Each application may have one or more FQDNs associated with the Local Content Network.

FQDNs may define “slices of the local content network,” for example, in a sense that network resources may be used to operate on FQDN. For example, a content object may be published and retrieved through an FQDN. Caching space used to hold the object, the bandwidth used to transmit it to/from clients and internally between local content network nodes, may be considered to be located inside the local content network slice dedicated to the FQDN.

The role of CFEAC may be to define client-FE mappings for each FQDN and for each potential client. Mapping may satisfy goals per-FQDN and/or globally. Mapping may also comply with or satisfy some constraints.

An example of a goal, or constraint, may be minimization of “FQDN load,” e.g., network usage associated with an FQDN. Network usage may be one or more of bandwidth usage on internal links, opportunistic caching space and CPU usage. Non-opportunistic caching space, which may store authoritative copies of content for an FQDN, may not be influenced by Front End distribution. A goal or constraint, such as minimization, may be a global goal, for example, to minimize the sum of all FQDN loads for content objects that are distinct between FQDNs. FQDNs may be “merged,” e.g., from Client-Front End association stand point, for example, when there is a non-negligible amount of content object reuse between certain FQDNs.

An example of a goal, or constraint, may be to provide appropriate Quality of Service/Experience for one or more end users. For example, certain FQDNs may be classified as “premium” while other FQDNs may be classified as “normal” level of service. Level of service may be expressed, for example, as the aggregate throughput in/out between Front End node and WTRUs. Level of service may take into account network characteristics, e.g., delay/jitter over a link between a WTRU and Front End nodes.

There may be changes in FQDN mapping. Connected clients may not switch immediately in response to mapping changes. Connected clients may change at the next opportunity. An opportunity may be the next time they re-open the session, such as when a cached DNS entry was flushed from the WTRU's DNS resolver, e.g., due to a timeout.

CFEAC may monitor network conditions. Conditions may be utilized as input. In an example, CFEAC may receive measurement messages from each Front End. Information (e.g., measurements) may be pulled from Front Ends (e.g., using NetConf GET requests). Front ends may send information asynchronously over HTTP to CFEAC, for example, when CFEAC registers for updates. Measurements may include actual measurements and/or estimations of quantities of interest. “FQDN load” measurement records may include, for example, the FQDN, aggregated bandwidth between the Front End node and other internal CIS nodes in relation to the FQDN, caching space used by objects in the FQDN, etc. Quality of Service or Experience measurements or estimations may include, for example, the FQDN, aggregated bandwidth between the Front End node and WTRUs in relation to the FQDN, average and/or standard deviation of client's delay/jitter measured at the Front End and/or measured on the client side, which may be reported to the Front End, etc.

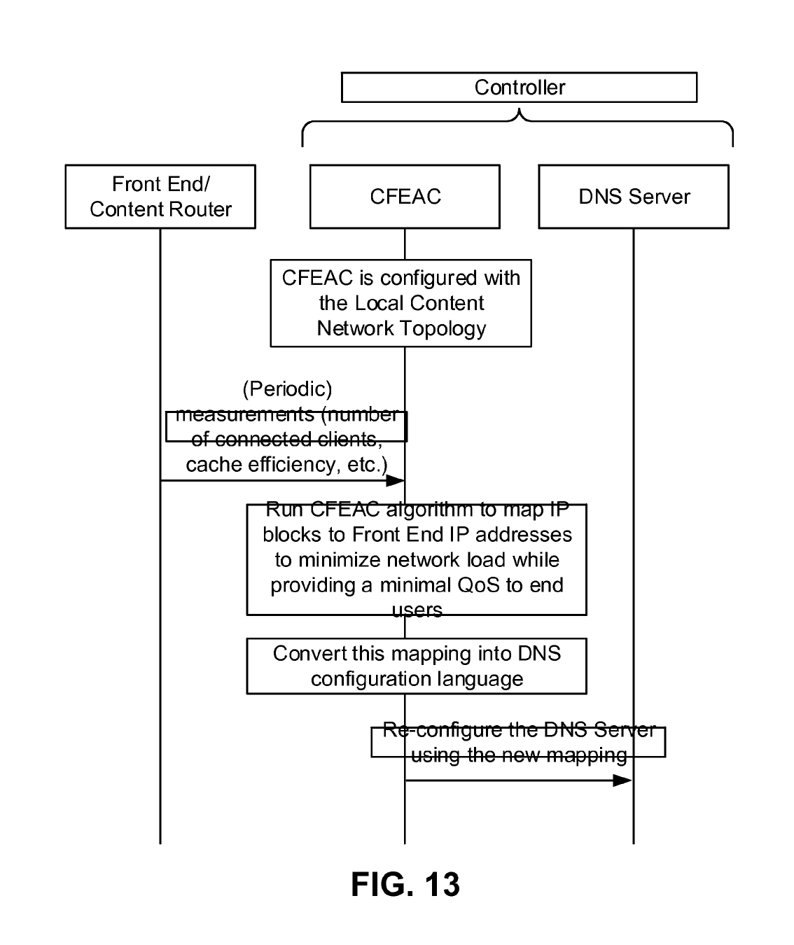

FIG. 13 is a diagram illustrating an example of a Client-Front End Association Algorithm in the Context of an Application.

An example of a CFEAC algorithm for an FQDN may be, for example, to measure the “FQDN” load and Quality of Service for present end users of the FQDN. For each potential client (e.g., each IP address or IP block) of the FQDN, an algorithm may evaluate the effect of mapping to one or more Front Ends. An FE may not be considered further for a given client, for example, when a new QoS, e.g., for a particular client and/or other existing clients, is worse than an acceptable threshold. An FE providing the lowest combined FQDN load may be selected, for example, when an FE is out of bounds relative to an acceptable threshold. A combined FQDN load may be, for example, a sum of all FQDN load.

Additionally, CFEAC may monitor the loading of each FE and assign new WTRU connection requests away from more heavily loaded FEs towards more lightly loaded FEs. CFEAC may combine network monitored information with FE information to steer WTRU connections away from FEs which are experiencing congestion on at least one of their network links towards FEs with less congested links. A QoS may be evaluated by the total number of clients attached to an FE, for example, without considering the FQDNs they are connected to. A threshold may be a maximum value for the number of clients. An FQDN load may be evaluated as the minimal number of internal links between one or more Front Ends used by clients of these FQDNs plus any additional internal Content Routers holding content for this FQDN. An algorithm may, for example, be reevaluated periodically or each time a new client connects or leaves the system.

More complex CFEAC algorithms may be devised, for example, to take into account caching efficiency within a slice of a network defined by a given FQDN. Caching efficiency may be measured and fed as input to the CFEAC. An algorithm may attempt to limit the number of Front Ends used by FQDNs with higher caching efficiency, for example, to further reduce the traffic over internal links. This limitation may be achieved, for example, by adding a function of caching efficiency as a multiplying factor to the FQDN load evaluation. An example of a function may be (1+caching efficiency), where caching efficiency is a positive number. Composition (e.g., average) of caching efficiency evaluation for an FQDN may be reported by each Front End. Caching efficiency at a Front End may be, for example, the number of cache hits per 1000 requests.

A result of an algorithm may be expressed as a mapping between IP blocks (e.g., clients) and one or more Front Ends. A result may indicate, for example, the three most suitable Front Ends in order of suitability. Mapping may be translated into a DNS Server configuration, for example, using “view” functionality of a bind DNS Server implementation. Different A/AAAA records may map a given FQDN to different Front End IP addresses, for example, depending on the IP block of the requesting client.

Edge caching in a 3GPP network with direct interconnects may be used to support IP clients in an ICN content network. A network of interconnected 3GPP cells may offer in situ content storage capabilities to application. Content may be cached in any one of the interconnected cells. This local storage point (instead of a remote cloud server) may be used to service a local user. 3GPP bearers may need to be properly managed (e.g., set up and terminated).

A 3GPP device may connect to a 3GPP network with a capability for content management across a distributed network of Small Cells. As previously indicated, a client device may use, for example, DHCP, to connect to an ICN network, e.g., to a Front End node, and to obtain an IP address. Connections in a 3GPP network may be more complicated.

A 3GPP network may differ from an ICN network with respect to connection terminations. As previously indicated for an ICN network, a decision to terminate a connection based on requested content may comprise viewing requested content, e.g., by examining the DNS query (e.g., FIG. 7), and making a decision to terminate the connection at the Front End (or externally). In 3GPP, connections may be made to an APN, which may be considered an IP network. While an external internet may be a type of APN, internal Small Cell network may not be the same APN as the external internet. A decision to terminate a connection (e.g., terminate the bearers/GTP tunnels) at a local small cell may be made up front rather than according to the procedure in FIG. 7.

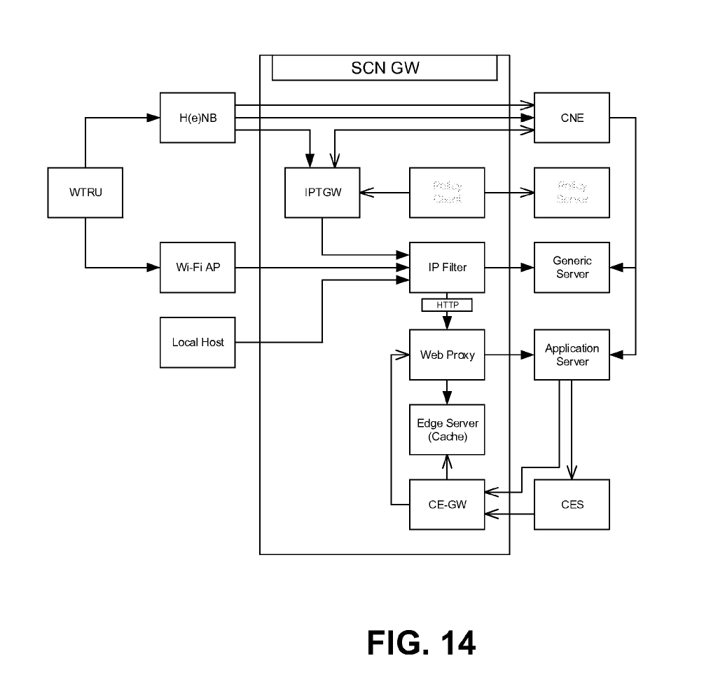

FIG. 14 is a block diagram illustrating an example of an architecture for a Small Cell Network Gateway (SCN GW). An IPTGW may be responsible for anchoring IP Flows. In an example, an IPTGW may operate similar to a Gateway GPRS Support Node (GGSN), except that IPGTW is local to a small cell network. Caching components may comprise, for example, Content Enablement Gateway (CE-GW), Edge Server and Web Proxy. Edge Server may store content. Web Proxy may decide where to route content requests, e.g., to local cache or to an application server outside the SCN. An IP Filter may act as a focal point/bridge between the SCN and the public Internet. In addition, a Policy Client is shown. Policy control (e.g., operator policy control, content publisher policy control) may be exercised over operations of the SCN GW. The Policy Client may not exist, such as when policy is hardcoded within the SCN GW.

Within the SCN, interfacing through the SCN GW may be a Home (evolved) Node B (H(e)NB) and WiFi Access Point (AP). The H(e)NB may interface to the IPTGW or the core network (CNE), for example, for locally anchored or core network anchored data flows, respectively. H(e)NB may be an LTE Small Cell and HNB may be a UMTS/3GPP Small Cell. They may be considered synonymous. A local host may connect to the SCN GW, for example, when a local application server is within a SCN. For example, if a small cell network is an enterprise, local file servers may be a local host.

Outside the small cell network, there may be a core network. An application server may have content that may be cached locally within the SCN. A generic server may be an application server that may provide content that is not cached. A Policy Server may provide policy to the SCN GW, e.g., to control the actions of the SCN GW. The policy server may provide enhanced policy compared to an Access Network Discovery and Selection Function (ANDSF) Server. A Content Enablement Server (CES) may interact with application servers that wish to cache their content locally and to manage the CE-GW so that content is placed within the Edge Server. While not shown in FIG. 14, CES and Policy Server may be in the mobile core network, e.g., under the control of an operator.

An end user device (WTRU) may be attached to the H(e)NB and WiFi AP. While the layout is shown with a single WTRU, the SCN GW system may support a number of simultaneous users, such as users who attach through the H(e)NB and WiFi AP simultaneously. SCN GW may be able to support some WiFi APs simultaneously and some H(e)NBs simultaneously.

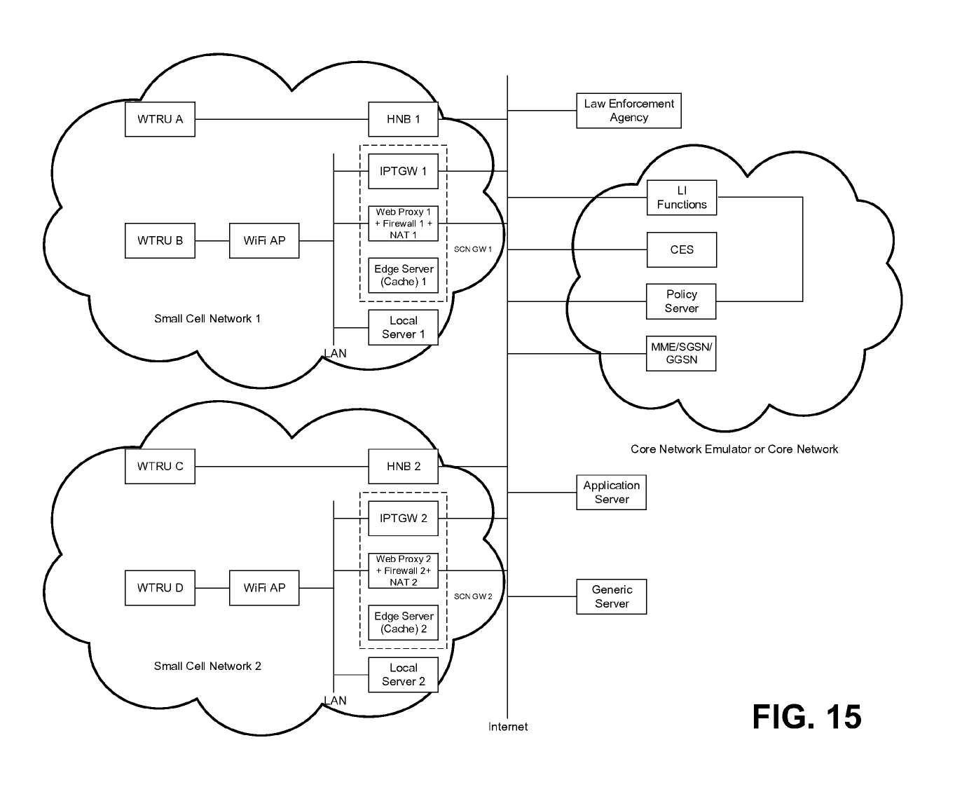

FIG. 15 is a block diagram illustrating an example of SCN and core network architecture. SCN1 and SCN2 may each comprise an HNB, WiFi AP, SCN GW and local server. There may be several users in each SCN, which may be attached to HNB or WiFi AP using their respective technologies. SCN GW may have an IPTGW, a Web Proxy (e.g., with a firewall and a network address translation (NAT) function), and an Edge Server. The CE-GW is not shown. Content may be cached at the Edge Server. A local area network (LAN) in an SCN may perform routing among WiFi AP, SCN GW and local server. HNB and/or SCN GW may have connections to the Internet.

The core network may contain, for example, Mobility Management Entity (MME), Serving GPRS Support Node (SGSN), and GGSN. Lawful Interception (LI) Functions, Policy Server and CES are shown separately. LI functions may interface to the Policy Server, e.g., to allow the LI functions to affect the policies based on the surveillance status of individual users. A Generic Server may be, for example, a public website whose content is not cached at an Edge Server. Application Server may be a public website whose content may be cached at an Edge Server. A Law Enforcement Agency (LEA) may interact with the LI Functions within the core network to enable or disable surveillance of particular users.

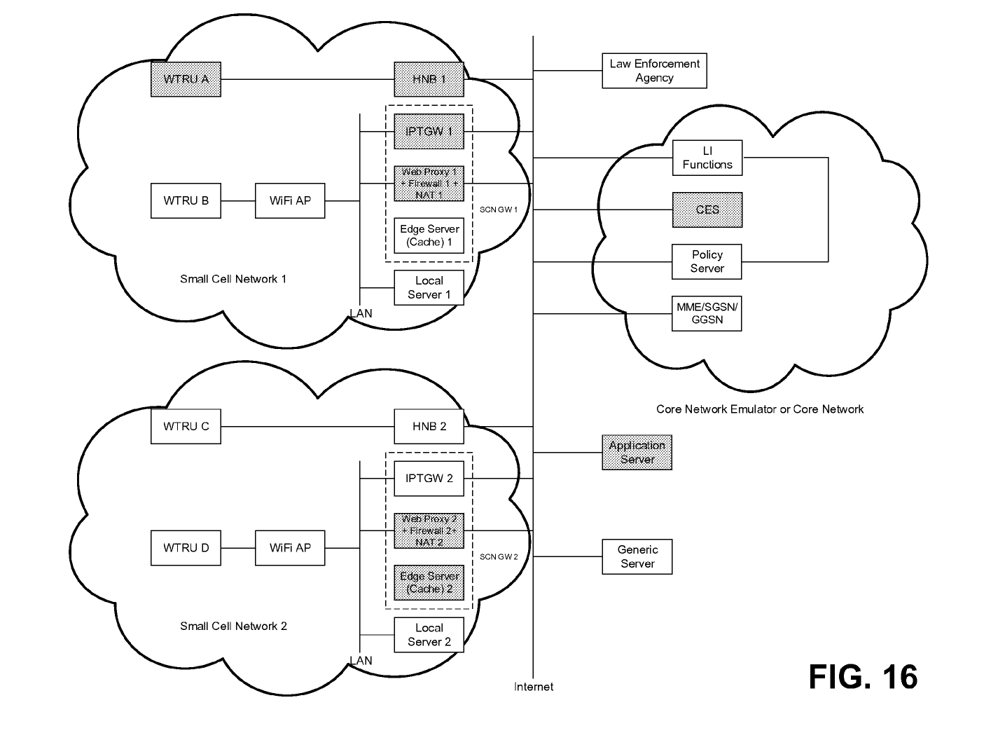

FIG. 16 is a block diagram illustrating an example of a cache location anchoring topology within the SCN and core network architecture shown in FIG. 15.

An SCN (e.g., each SCN) may have an Edge Server that may cache (e.g., or otherwise store) content. Cache may be populated in a variety of ways. An Edge Server (e.g., each Edge Server) may have unique content. The CES within the core network may be made aware of content stored in the Edge Server in each SCN. The CES may push this information to the Web Proxy in each SCN. CES may convey information to each Web Proxy, e.g., so that each Web Proxy is informed from where to pull content “x” when it terminates a request from a WTRU. For example, Edge Server 2 may have content “x”, which may have originated from an Application Serve, and may forward this information to each Web proxy.

A Packet Data Protocol (PDP) context is activated, for example, when a device attaches to the core network through an HNB. The Access Point Name (APN) used may be the IPTGW in the same small cell network. A WTRU may indicate to the network that it is requesting local content service, for example to connect to the APN. A WTRU may indicate to the network that it is requesting local content using a variety of methods.

A device may be provisioned with a “local IPTGW” APN or an end user may enter the “local IPTGW” APN using their device's connection manager. A PDP context activation message may include the “local IPTGW” APN. An SGSN/MME may realize that the “local IPTGW” APN connection may be anchored at the IPTGW located in the same SCN as the H(e)NB and device requesting the connection, for example, upon receipt of an activation message by the network (SGSN or MME). The SGSN/MME may effectuate the establishment of the PDP context, anchored at the IPTGW. A connection may be established. Applications within the end user device may make use of the PDP context, which may be anchored at the IPTGW. A WTRU may use the PDP context for one or more applications or may use it for specific applications that may benefit from a connection terminated at the IPTGW.

A device may use a macro-based APN. The device may, for example, be provisioned with a macro-based APN or an end user may enter it via a connection manager. A PDP context activation message may include a mac-based APN identity. An SGSN/MME may realize that a user device is located in a small cell network, serviced by a local IPTGW, that may be used as an anchor for one or more IP Flows, for example, upon receipt of an activation message by the network (SGSN or MME). The SGSN/MME may effectuate establishment of a PDP context, anchored at the IPTGW. A connection may be established. Applications within the end user device may make use of the PDP context, which may be anchored at the IPTGW. A WTRU may use the PDP context for one or more applications or may use it for specific applications that may benefit from a connection terminated at the IPTGW.

The device may establish two or more PDP contexts. For example, the device may establish a PDP context anchored locally at the IPTGW within the same SCN as the WTRU. The device may establish a PDP context anchored at the SGSN/SGW located in the core network. An end-user device may be made aware of the local IPTGW, for example, by provisioning a priori or by an end-user entering the local IPTGW ID via a connection manager. There may be one or more (e.g., two) PDP context requests. For example, there may be a PDP context request with a local IPTGW APN and/or a PDP context request with the macro APN. The MME/SGSN may be aware of where to anchor each of these connections. Applications running on an end user device may select an interface to use. Applications intended to make use of local content may be configured to use the local connection, which may allow for use of the IPTGW and content that is cached locally (or cached at a neighbor small cell network). An appropriate APN may be selected. WTRU A may attach to the core network via HNB 1 and the PDP context may be anchored at IPTGW 1. A WTRU may request, e.g., via Hypertext Transfer Protocol (HTTP), content that may be cached at Edge Server 2, located in SCN 2. IPTGW 1 may receive the request, e.g., an uplink request. The request may be removed from the GTP tunnel and placed onto the LAN within small cell network 1.

A process or processes similar to various processes discussed with respect to FIGS. 8-12 may be utilized to achieve an overall procedure to establish a connection, publish and retrieve content from the Local Content Network. Web proxies attached to 3GPP-based Small Cell Gateways may be used to establish a connection, publish and retrieve content from the Local Content Network.

Web Proxy 1 may, for example, terminate a session carrying a request, examine the HTTP request, and determine that the content is located at Edge Server 2. Web Proxy 1 may formulate a request directed to Web Proxy 2 and push it onto the Internet. Web Proxy 2 may capture this request and route it onto the LAN within SCN 2. Edge Server 2 may send the requested content to Web Proxy 1 via Web Proxy 2 and the Internet. Web Proxy 1 may receive the content and push it towards IPTGW 1, which may satisfy the original content request from the WTRU terminated at Web Proxy 1. IPTGW 1 may receive the content and push it into the GTP tunnel for the WTRU, which may exist between IPTGW 1 and the HNB. HNB may receive the content, remove the content from the GTP tunnel and send the content, e.g., over-the-air, to the WTRU.

Regarding caching functionality, a Web Proxy may be aware of content cached in SCNs, including other SCNs. A Web proxy may be made aware by the CES.

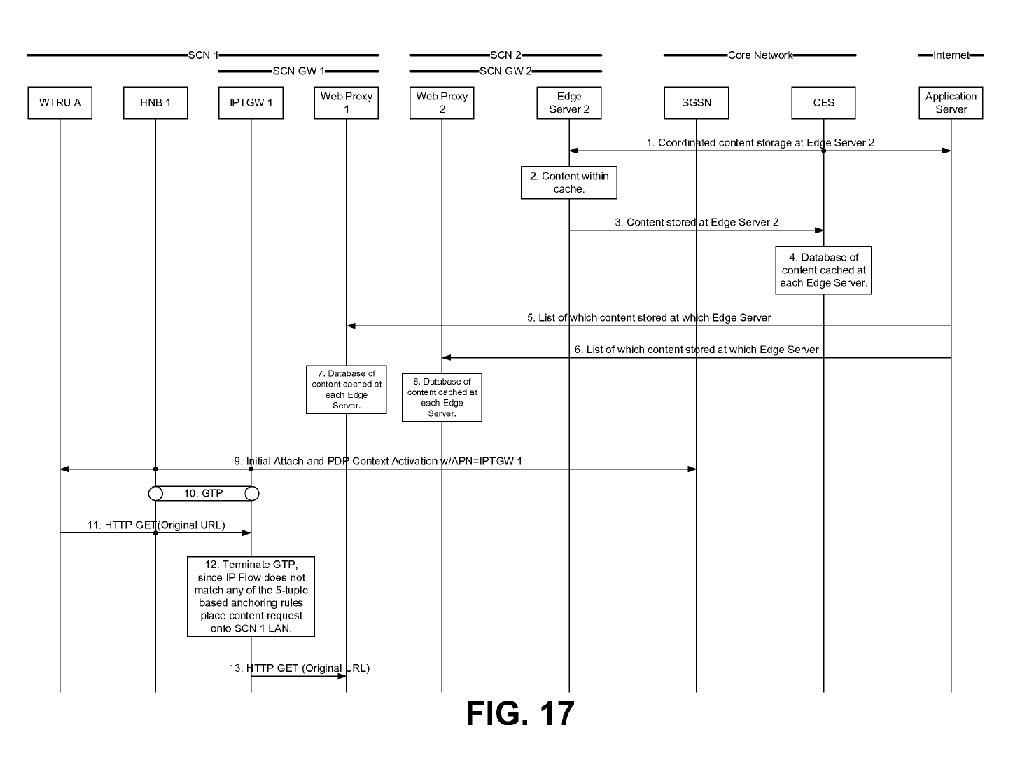

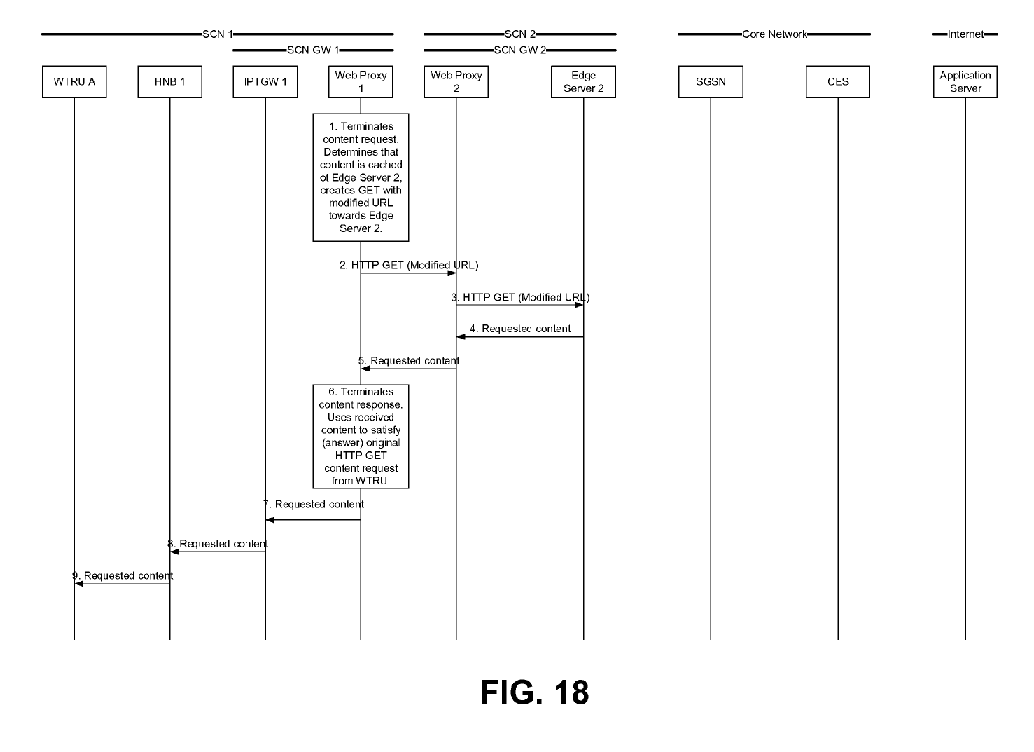

FIGS. 17 and 18 are diagrams illustrating an example of a message sequencing for Cache Location Anchoring. Content may be distributed in the network. Referring to FIG. 17, at 1, content may be stored at Edge Server 2 by the Application Server. The CES may facilitate direct transfer of content from the Application Server to Edge Server 2.

At 2, an indication may be provided that content transfer was completed successfully. At 3, Server 2 may inform CES about a Uniform Resource Locator (URL) for content cached at Edge Server 2. At 4, CES may update a list indicating which content is located at which Edge Server. A list may indicate, for example:

| Original URL | Cache URL |
|---|---|
| www.youtube.com/movieXyz | Edge Server 2/movieXyz |
| www.netflix.com/movieAbc | Edge Server 2/movieAbc |

Referring to FIGS. 17, at 5 and 6, CES may disseminate the list to Web Proxy 1 and Web Proxy 2; 1-6 may indicate one of several example methods to inform Web Proxies about content cached at each SCN. For example, Web Proxies may be hardcoded to know which content is cached at each small cell network.

Referring to FIGS. 17, at 7 and 8, a list may be disseminated at each Web Proxy. In an example, a list may be originated locally at each Web Proxy, which may omit 3, 4, 5, and/or 6.

At 9, an IP device may connect to and retrieve content from a network (e.g., a 3GPP-based network equivalent to a network described in FIGS. 7-12). At 9, a user device may connect to the core network. A device may camp on HNB 1, perform an Initial Attach and activate a PDP Context with the SGSN. The PDP Context may have the APN set to IPTGW 1, thereby anchoring the IP Flow at IPTGW 1. The SGSN may cause the establishment of the PDP context between the WTRU and IPTGW 1. At 10, a GTP tunnel between HNB 1 and IPTGW 1 may result from 9.

Referring to FIG. 17, at 11, a user may issue an HTTP GET with a specific URL. This request may reach IPTGW 1, e.g., encased in the GTP tunnel between HNB 1 and IPTGW 1.

Referring to FIG. 17, at 12, IPTGW 1 may remove and/or terminate the GTP header and examine the request. The content request may be examined, e.g., by comparing it to the list, such as a list of 5-tuple rules used for anchoring.

Referring to FIG. 17, at 13, the content request may be dropped onto the LAN local to SCN 1 and captured by the Web Proxy.

Referring to FIG. 18, an example is provided showing how an IP client is provided with requested content. At 1 of FIG. 18, Web Proxy 1 may terminate the HTTP GET request. Web Proxy 1 may examine the request and determine that the content is located, for example, at Edge Server 2.

At 2, Web Proxy 1 may dispatch an HTTP GET with a modified URL towards SCN 2. At 3, Web Proxy 2 may pick up the request and forward it to the Edge Server within SCN 2, for example, according to a NAT function in Web Proxy 2.

At 4, Edge Server 2 may service the request and place the requested content onto the LAN of SCN 2. At 5, Web Proxy 2 may catch the response and NAT it out onto the Internet.

At 6, the response may be terminated at Web Proxy 1. Web Proxy 1 may use the content received to satisfy the original HTTP GET request from the WTRU. At 7, Web Proxy 1 may push the response onto the LAN in SCN 1.

Referring to FIG. 18, at 8, IPTGW 1 may catch the response. IPTGW 1 may route the response to the WTRU. IPTGW 1 may know where to route the response based on an assignment during PDP context activation. IPTGW 1 may have a destination IP address equal to the IP address assigned by the IPTGW during PDP context activation. IPTGW 1 may route the response by pushing the response to HNB 1 using the GTP tunnel that exists between HNB 1 and IPTGW 1. The GTP tunnel may exist for a particular user. At 9, HNB 1 may push the packet over-the-air to the WTRU.

Systems, methods, and instrumentalities have been disclosed for supporting IP clients in ICN content network. Techniques allow IP clients in IP networks to attach to ICN networks. DNS-based redirection techniques for local content services in IP networks may permit DNS-based content anchoring. 3GPP signaling in ePC networks may permit Edge server cache location anchoring. A network may select a respective network element for a client to attach to as an anchor node in association with setting up an IP socket or before an IP socket is set up. A client may establish an IP session with the anchor network element. An IP connection may remain terminated (anchored) at a network element during an application's IP session. A client may run any appropriate application-level protocol for content management (e.g., HTTP) over the IP socket. The anchor element may act as a “proxy” server toward the client for content functionality that may be dynamically distributed across an ICN network. A network may process client application communications in a manner appropriate for ICN architecture within the respective network.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

Systems, methods, and instrumentalities are provided for supporting IP clients in ICN content network. Techniques allow IP clients in IP networks to attach to ICN networks. DNS-based redirection techniques for local content services in IP networks may permit DNS-based content anchoring. 3GPP signaling in ePC networks may permit edge server cache location anchoring. A network may select a respective network element for a client to attach to as an anchor node in association with setting up an IP socket or before an IP socket is set up. A client may establish an IP session with the anchor network element. An IP connection may remain terminated (e.g., anchored) at a network element during an application's IP session. A client may run an appropriate application-level protocol for content management (e.g., HTTP) over the IP socket. The anchor element may act as a proxy server toward the client for content functionality that may be dynamically distributed across an ICN network. A network may process client application communications in a manner appropriate for ICN architecture within the respective network.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

1-82. (canceled)

83. A method for providing Information Centric Networking (ICN) within a network, comprising:
detecting a domain name server (DNS)-based request for content from a wireless transmit/receive unit (WTRU);
selecting a network element for the WTRU to attach to, wherein the network element is selected without regard to properties of the content requested;
establishing an Internet Protocol (IP) session between the network element and the WTRU, wherein the WTRU is anchored at the network element;
redirecting the DNS request for content to an ICN node; and
providing the content to the WTRU through the selected network element.

84. The method of claim 83, wherein detecting includes establishing a DNS proxy or a DNS server to intercept or receive the DNS request.

85. The method of claim 83, wherein the network element delivers the content to the WTRU using a TCP socket or a UDP socket.

86. The method of claim 83, wherein the network element accepts the request for content using IP protocol, receives the content using ICN protocol, and delivers the content to the WTRU using IP protocol.

87. The method of claim 83, further comprising specifying the content with a domain name.

88. The method of claim 87, further comprising specifying the level of service for the domain name.

89. The method of claim 83, wherein selecting the network element is based upon at least one of load information, the WTRU's location, or expected traffic requirements.

90. The method of claim 83, further comprising dynamically distributing the content across a plurality of nodes.

91. The method of claim 83, wherein providing includes retrieving content that is cached in the network.

92. The method of claim 83, wherein providing includes communicating with an application service provider to receive the content.

93. A network element for providing Information Centric Networking (ICN) within a network, comprising:
a processor configured to:
receive instructions to attach to a wireless transmit/receive unit (WTRU) that is requesting content and establish an Internet Protocol (IP) session, wherein the network element is selected without regard to properties of the content requested;
accept a domain name server (DNS)-based request for content from the WTRU;
redirect the DNS request for content to an ICN node;
receive the content from the ICN node; and
provide the content to the WTRU.

94. The network element of claim 93, wherein the WTRU is anchored to the network element for the duration of the IP session.

95. The network element of claim 93, wherein the network element is selected based upon at least one of load information, the WTRU's location, or expected traffic requirements.

96. The network element of claim 93, wherein the network element accepts the request for content using IP protocol, receives the content using ICN protocol, and delivers the content to the WTRU using IP protocol.

97. The network element of claim 93, wherein the network element delivers the content to the WTRU using a TCP socket or a UDP socket.

98. A network server for providing Information Centric Networking (ICN) within a network, comprising:
a processor configured to:
detect a domain name server (DNS)-based request for content from a wireless transmit/receive unit (WTRU);
establish a DNS proxy or a DNS server to intercept or receive the DNS request;
select a network element for the WTRU to attach to, wherein the network element is selected without regard to properties of the content requested;
instruct the network element to establish an Internet Protocol (IP) session with the WTRU, wherein the WTRU is anchored at the network element;
redirect the DNS request for content to an ICN node; and
provide the content to the WTRU through the selected network element.

99. The network server of claim 98, wherein the network element is selected based upon at least one of load information, the WTRU's location, or expected traffic requirements.

100. The network server of claim 98, wherein the processor is further configured to dynamically distribute the content across a plurality of ICN nodes.

101. The network server of claim 98, wherein the processor is further configured to retrieve content that is cached in the network.

102. The network server of claim 98, wherein the processor is further configured to communicate with an application service provider to receive the content.
